(19) United States
(12) Patent Application Publication
(10) Pub. No.: US 2007/0261932 A1
(43) Pub. Date: Nov. 15, 2007

(54) Friction clutch with multiple belleville springs

(75) Inventors: Przemyslaw Zagrodzki, West Lafayette, IN (US); Neha Vaidya, Zionsville, IN (US)

Correspondence Address: KRIEG DEVAULT LLP, ONE INDIANA SQUARE, SUITE 2800, INDIANAPOLIS, IN, 46204-2079, US

(73) Assignee: Raytech Composites, Inc.

(21) Appl. No.: 11/432,913

(22) Filed: May 12, 2006

(51) Int. Cl. F16H 48/20

(52) U.S. Cl. 192/70.27

(57) ABSTRACT

A torque transfer apparatus is disclosed. The apparatus includes a housing, a friction pack including at least one pair of interacting surfaces operable to transfer torque, a first Belleville spring contacting a first region of the plate and contacting a first region of the housing, and a second Belleville spring contacting a second region of the plate and contacting a second region of the housing. In one embodiment the springs comprise a unitary piece. In other embodiments the springs may face the same or opposite directions.

### TECHNICAL FIELD

The technical field relates generally to torque transfer apparatus such as friction clutches or brakes including, for example, those used in limited slip differentials, and relates more specifically to torque transfer apparatus including Belleville springs.

### BACKGROUND

Torque transfer apparatuses are useful in a wide variety of applications including, for example, differentials, clutches and friction brakes for passenger vehicles, commercial vehicles and equipment, industrial vehicles and equipment, agricultural vehicles and equipment, and others. These torque transfer apparatuses and others include at least one or more pairs of surfaces which interact to transfer torque. Typically such apparatuses include plates or disks which may be arranged, for example, in a friction pack. Applying force to the plate(s) or disk(s) can generate frictional torque resulting in torque transfer. A Belleville spring is one example of a device useful for applying such force.

### SUMMARY

One embodiment according to the present invention includes a torque transfer apparatus including a housing, a friction pack including a plurality of plates, a first Belleville spring contacting a first region of the plate and contacting a first region of the housing, and a second Belleville spring contacting a second region of the plate and contacting a second region of the housing.

Another embodiment according to the present invention includes a torque transfer device including a hub, a housing, and a grouping of rotatable plates. A first set of the plates are operatively coupled to and rotatable with the hub. A second set of the plates are operatively coupled to the housing. At least two Belleville springs contact at least one of the plates effective to apply force to at least two regions of the plate. In one embodiment the springs comprise a unitary piece.

A further embodiment according to the present invention includes a frictional torque apparatus. The apparatus includes a friction pack including a grouping of disks, a hub engaging a first set of the disks, a housing engaging a second set of the disks, and at least two spaced apart Belleville springs contacting the friction pack effective to apply force to the friction pack substantially at two spaced apart regions.

One object of the present invention includes improvement of pressure distribution at contact interfaces inside a friction pack.

Additional embodiments, aspects, and advantages of the present invention will be apparent from the following description and claims.

### BRIEF DESCRIPTION OF THE FIGURES

FIG. 1 is a simplified schematic view of a vehicle.

FIG. 2 is a partial sectional view of a prior art clutch.

FIG. 3 is a partial sectional view of a limited slip differential clutch.

FIG. 3A is an enlarged view of a portion of the limited slip differential clutch of FIG. 3 in a first state.

FIG. 3B is an enlarged view of a portion of the limited slip differential clutch of FIG. 3 in a second state.

FIG. 4 is a partial sectional view of a limited slip differential clutch.

FIG. 5 is a partial sectional view of a limited slip differential clutch.

FIG. 6 is a partial sectional view of a limited slip differential clutch.

FIG. 7A is a top view of Belleville springs.

FIG. 7B is a side sectional view of a portion of the Belleville springs of FIG. 7A.

FIG. 8 is a partial sectional view of a limited slip differential clutch having stacked Belleville springs.

FIG. 9 is a partial sectional view of a limited slip differential clutch wherein the spacer plate is positioned between the housing and the Belleville springs.

FIG. 10 is a partial sectional view of a clutch that includes an actuator.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The inventors have identified a number of limitations associated with torque transfer devices. For example, the extent of contact area between a single Belleville spring and the first plate in a friction pack has significant influence on pressure distribution at contact interfaces inside the pack. If the spring is only in contact with the inner periphery of the first plate, the contact pressure at interfaces inside the pack is also concentrated close to the inner periphery. This non-uniform pressure distribution contributes to higher wear of the plates at the inner periphery. Furthermore, the frictional torque produced in these conditions is relatively low since the friction forces are concentrated at a small radius near the inner periphery. When the Belleville spring flattens and the pressure distributions along radius at interfaces inside the pack become more uniform, the frictional torque significantly increases. The inventors have conducted finite element modeling which demonstrates the pressure distributions along radius dependent on axial force or deflection of Belleville spring for single spring and for dual spring embodiments. This torque increase is noticeably greater than what is expected from the increase of the axial force. In other words, while the frictional torque is expected to be proportional to the axial force, it suddenly changes when the Belleville spring flattens. This type of torque behavior may contribute to major problems including judder or other forms of vibrations in torque transfer devices such as clutches in limited slip differentials.

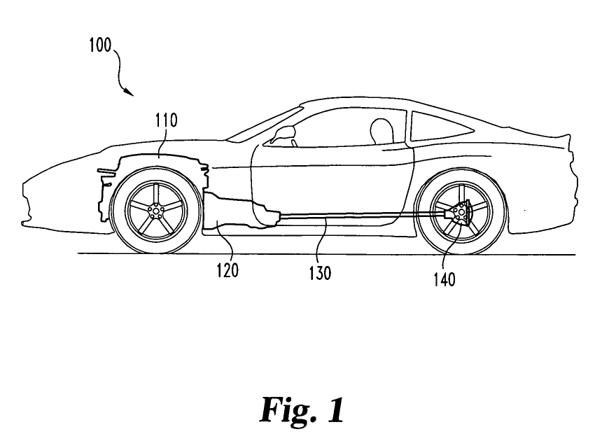

With reference to FIG. 1 there is shown vehicle 100 including engine 110, transmission 120, drive shaft 130, and limited slip differential 140. Torque generated by engine 110 is coupled to differential 140 through transmission 120 and shaft 130. Differential 140 transfers input torque to drive the wheels of vehicle 100. Differential 140 is one non-limiting example of a torque transfer apparatus according to one embodiment of the present invention. As shown in FIG. 1, vehicle 100 is a rear wheel drive passenger vehicle and differential 140 is a rear differential, however, a variety of other differentials equipped with friction clutches are contemplated within the scope of the present invention. For example, front wheel drive differentials, axle differentials in full and part time four wheel drive vehicles, and in all wheel drive vehicles are contemplated within the scope of the present invention. Differentials according to various embodiments of the present invention can be for all types of passenger vehicles including cars, trucks, and buses, for vehicles other than passenger vehicles including, for example, semi-tractors and agricultural and industrial vehicles, and for applications other than vehicles, for example, agricultural and industrial equipment. A variety of additional torque transfer devices that use friction clutches equipped with Belleville springs, the latter employed either as a source of perpetual axial force applied to the friction pack or as buffering springs between any kind of actuator and the friction pack are also contemplated within the scope of the present invention. For example, friction clutches in vehicular transmissions, transfer cases, start-up clutches, friction brakes including wet wheel brakes. Clutches according to various embodiments of the present invention include automatic transmission holding clutches, shifting clutches, direction clutches, powershift transmission clutches, power take off clutches, and differential clutches among others. These and other torque transfer devices known to those of skill in the art can be used in a variety of vehicles and other applications including, for example, those described above. Thus, while various figures herein are described in connection with a limited slip differential friction clutch, it is contemplated that the present invention includes a variety of other embodiments including, but not limited to, those described above.

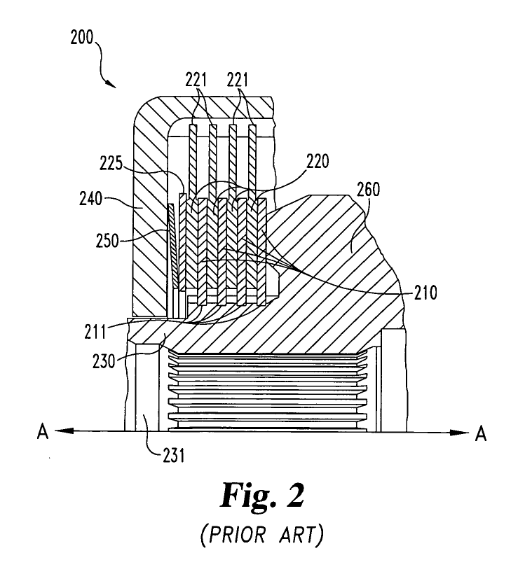

With reference to FIG. 2 there is shown a prior art limited slip differential clutch 200 having a single Belleville spring. Clutch 200 includes ring shaped plates or disks 210 and 220. Plates 210 include internal splines or teeth or keys 211 and plates 220 include external splines or teeth or keys 221. Teeth 211 engage hub or shaft 230 and plates 210 rotate with hub 230 substantially about an axis indicated by arrows A. Teeth 221 engage drum, retainer, or housing 240 and plates 220 rotate with drum 240 substantially about the axis indicated by arrows A, for example, in the case of a limited slip differential. Plates 210 are preferably alternately arranged with plates 220, so that the interface between adjacent plates is constituted by a surface of a plate 210 coupled to hub 230 and a surface of a plate 220 coupled to housing 240.

Clutch 200 is equipped with one or more devices which exert force on the friction pack substantially in the axial direction. This force brings disks 210 and 220 into contact which generates friction forces at the interfaces of plates 210 and 220 to produce frictional torque. In certain embodiments, for example, vehicular limited slip differentials, continuous torque is required from the clutch, and the clutch is always engaged. A device for exerting axial force in these and other embodiments includes a preloaded spring such as Belleville spring 250. Belleville spring 250 is preferably manufactured from steel and has a conical shape in the spring's free state. Belleville spring 250 is located between housing 240 and the plate 225.

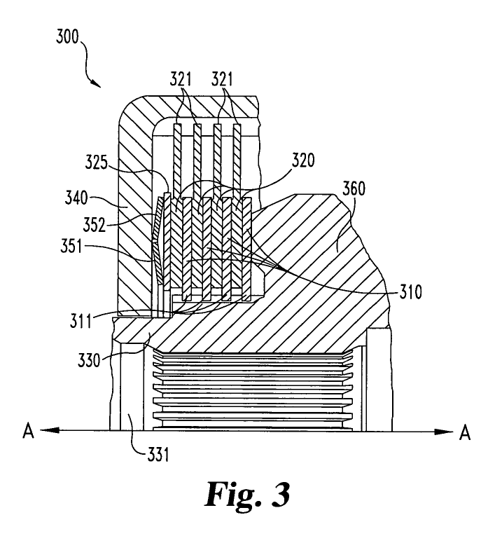

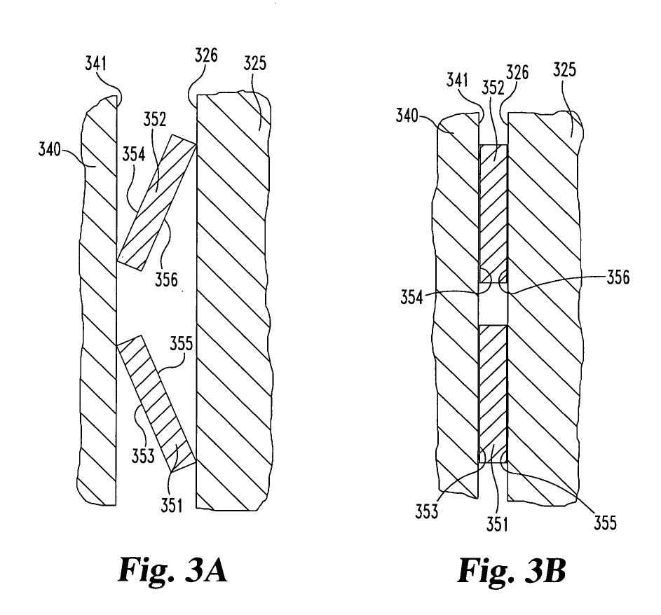

As shown in FIG. 2, Belleville spring 250 can be preloaded to produce a minimum torque required from the clutch. During operation, the clutch is required to produce a variable torque, exceeding that resulting from the preload. Higher torque can be produced, for example, by additional axial force acting on gear 260 (this force is a component of forces normally acting on gear teeth and is proportional to the torque transferred by the differential) in the direction toward the friction pack. Thus, gear 260 moves axially toward the pack and Belleville spring 250 deflects beyond the initial preload as is described in greater detail below in connection with FIGS. 3A and 3B.

With reference to FIG. 3 there is shown limited slip differential clutch 300 according to one embodiment of the present invention. Clutch 300 includes ring shaped plates or disks 310 and 320. Plates 310 include internal splines or teeth 311 and plates 320 include external splines or teeth 321. Teeth 311 engage hub or shaft 330 and plates 310 rotate with hub 330 substantially about an axis indicated by arrows A. Teeth 321 engage drum, retainer, or housing 340 and plates 320 rotate with drum 340 substantially about the axis indicated by arrows A, for example, in the case of a limited slip differential. Plates 310 are preferably alternately arranged with plates 320, so that the interface between adjacent plates is constituted by a surface of a plate 310 coupled to hub 330 and a surface of a plate 320 coupled to housing 340. The two interfacing surfaces are preferably made of dissimilar materials, most preferably of ferrous metal such as steel or cast iron against composite friction material, however, other combinations of materials can also be used. A variety of friction materials can be used, including paper-based composites, carbon composites, elastomeric materials, and sintered metals. This arrangement of plates 310 and 320 is an example of a friction pack. Friction packs including greater or fewer numbers of plates, multiple groupings of disks, for example in the case of axle differentials including multiple clutches, and other variations known to those of ordinary skill in the art are also contemplated as within the scope of the invention. Some further examples of clutch packs include packs with friction plates each having two layers of friction material on both sides sliding against steel plates, as in the illustrated embodiments, packs with single-sided friction plates, each of which has only one layer of friction material on one side, and each friction material faces bare metal surface of the adjacent plate, packs including various combinations the two aforementioned packs, where the plates inside the pack are double-sided while at least one plate on one end of the pack is single-sided.

As shown in FIG. 3, plate 325 is an apply plate or spacer plate which does not produce frictional torque and which rotates with the Belleville spring without substantial or any torque transfer (idle rotation). It is also contemplated, however, that Belleville springs 351 and 352 could directly contact the first working plate of the pack which does produce frictional torque. It is further contemplated that the Belleville springs could be positioned on the other end of the pack of plates, or between plates and could contact multiple plates, for example, in the case of Belleville springs positioned intermediate two or more plates. For example, the plates can be inserted between the side gear 360 and the pack of disks. For this purpose, the geometry of the side gear is modified in order to have a sufficiently wide supporting plane. Further, the Belleville springs will rotate with the side gear in this case and therefore the springs will preferably be concentrically positioned relative to the hub. The outer spring may or may not include structures for concentric positioning, however, the outer spring is not connected to the housing since it rotates relative to it.

It should be understood that in the preferred embodiment the Belleville springs 351 and 352 are positioned between the side gear 360 and the friction pack. Such an embodiment is an opposite counterpart of the embodiment shown in FIG. 3, in other words, a mirror reflection with respect to a vertical plane. In the most preferred embodiment the inner spring contacts the pack at inner periphery and the outer spring at the outer periphery when the springs are not fully flattened.

Limited slip differential clutch 300 further includes Belleville springs 351 and 352. In certain embodiments, for example, vehicular limited slip differentials, continuous torque is required from the clutch, and the clutch is always engaged. A device for exerting axial force in these and other embodiments includes preloaded springs such as Belleville springs 351 and 352. As used herein the term Belleville springs includes Belleville washer springs, disc springs, conical compression washers, cupped spring washers, and diaphragm springs. Belleville springs 351 and 352 are preferably manufactured from steel and have a conical shape in the spring's free state. Belleville springs 351 and 352 are one example of a dual Belleville spring configuration according to one embodiment of the present invention. As shown in FIG. 3, Belleville spring 351 is preferably positioned with a radially outer portion contacting housing 340 and a radially inner portion contacting plate 325, and Belleville spring 352 is positioned with a radially outer portion contacting plate 325 and a radially inner portion contacting housing 340. In such a configuration the Belleville springs can be said to face opposite directions.

As illustrated in FIG. 3, Belleville springs 351 and 352 are two separate substantially concentric springs, one preferably positioned inside the other (in other words, one spring is nested within the other spring). The outer radius of spring 351 is preferably smaller than inner radius of spring 352 so that if the springs are flattened there is at least a small radial clearance between them. Belleville springs 351 and 352 distribute force between inner and outer radial peripheries of the friction pack even at low axial load, when the springs 351 and 352 are not flattened. This configuration provides more uniform pressure distributions at interfaces inside the clutch and reduces local wear of friction surfaces and reduces torque variation upon flattening of the springs. It is also contemplated that Belleville springs 351 and 352 could be made from a single piece of metal with two or more radial bridges connecting the two spring portions. Furthermore, Belleville springs formed by any other technique or process are contemplated within the scope of the invention.

Springs 351 and 352 are preferably positioned substantially concentrically with the hub and housing. In order to maintain positioning, either or both of spring 351 and 352 can be equipped with two or more radially extending keys (not shown). The keys of spring 252 are preferably substantially aligned with axial grooves in housing 340 to prevent or reduce eccentric spring displacements. Similar keys could cooperate with grooves in plate 325 or another plate which contacts a spring. Other structures for ensuring the positioning of springs 351 and/or 352 are also contemplated as within the scope of the invention. For example, one or more axial projections from springs 351 and/or 352 could cooperate with one or more recesses formed in housing 340, plate 325 and/or another plate. In another example housing 340, plate 325 and/or another plate could include projections, or other structures that maintain the positioning of springs 351 and/or 352. Furthermore, separate retainers, connectors, couplers and/or other structures could be used to maintain the positioning of springs 351 and/or 352 relative to housing 340, plate 325 and/or another plate. Additionally, positioning of one of springs 351 and 352 could also be maintained by one spring limiting eccentric movement of the other. The foregoing modifications and variations as well as others can occur for embodiments where Belleville springs 351 and 352 are separate pieces, a single piece, or springs coupled or joined by any other technique including, for example, those described elsewhere herein.

In a preferred embodiment according to the present invention, Belleville springs 351 and 352 can be made from metal sheet of the same thickness and have substantially the same radial width and axial height, with the diameters of the two preferably concentric springs being different. Additional embodiments contemplate variations between Belleville springs. The radial width of Belleville springs 351 and 352 can be different or identical. Similarly, the axial height of Belleville springs 351 and 352 in a free state can be different or identical according to various embodiments of the invention. Furthermore, Belleville springs 351 and 352 can be made from metal sheet of different thickness. The foregoing modifications and variations as well as others can occur for embodiments where Belleville springs 351 and 352 are separate pieces, a single piece or, for example, two joined pieces.

A number of variations and modifications of limited slip differential clutch 300 including those described above are contemplated as within the scope of the present invention. Additionally, it is contemplated that, either the wall of the housing 340, or plate 325, or both, could be stepped or otherwise shaped to accommodate different dimensions between springs 351 and 352 such as variations in thickness. Additionally, although the outer diameter of the conical portion of spring 352 is close to the outer diameter of the friction surfaces of plates 310 and 320, additional embodiments contemplate different dimensions and/or positioning of spring 352 so that its outer diameter is further radially outward or further radially inward than is shown in FIG. 3. For example, the outer diameter of spring 352 can either be equal, greater, or smaller than the outer diameter of friction surfaces. Similarly, although FIG. 3 shows that the inner diameter of the conical portion of Belleville spring 351 is close to the inner diameter of the friction surfaces of plates 310 and 320, additional embodiments contemplate different dimensions and/or positioning of spring 351 so that its inner diameter is further radially outward or further radially inward than as shown in FIG. 3. For example, the inner diameter of the spring 351 can either be equal, or greater, or smaller than the inner diameter of friction surfaces. Additionally, various embodiments according to the present invention include more than two Belleville springs, for example, two identical or similar springs could be stacked; the stacked springs could be positioned in the same or similar positions as shown in the various embodiments illustrated and described herein. Springs stacked together, either inner or outer, preferably have identical or similar radial widths, with either inner springs wider than the outer springs or vice versa.

With reference to FIGS. 3A and 3B there are shown enlarged views of portions of limited slip differential clutch 300 of FIG. 3 in different states. FIG. 3A illustrates springs 352 and 351 positioned between surface 341 of housing 340 and surface 326 of plate 325. In FIG. 3A the force on springs 351 and 352 is sufficiently low that surfaces 354 and 356 of spring 352 and surfaces 353 and 355 of spring 351 are substantially exposed. At sufficiently high force springs 351 and 352 partially, completely, or substantially flatten. In a substantially flattened state, as shown in FIG. 3B, surfaces 353 and 354 contact surface 241 and surfaces 355 and 356 contact surface 326 across substantially the entire radial width of springs 351 and 352. Thus, in the stages of clutch operation when the spring load is low, spring 351 and 352 contact housing 340 and plate 325 only at their inner and outer peripheries, and in the stages when the spring load is increased, greater portions of springs 351 and 352 contact housing 340 and plate 325 with the contact amount of surface area increasing up to the configuration shown in FIG. 3B. In a typical limited slip differential applications the states of springs 351 and 352 are somewhat different than described above. For example, the springs may be initially pre-tensioned and therefore noticeably, but not completely flattened. In such an embodiment, what is shown on FIG. 3A is exaggerated and the contact surfaces 341 and 326 would be across narrow annular paths rather than at single points. Thus, while FIGS. 3A and 3B show the full theoretical range of configurations that Belleville springs could assume, typical embodiments, such as a limited slip differential, will operate with Belleville springs moving in a subset of the full theoretical range. During the service life of a differential, the plates in the pack are subjected to wear and the total pack length decreases. As a consequence, initial pre-tension of the springs decreases and they look more like those in FIG. 3A, however even with substantial wear there the embodiment illustrated in FIG. 3A is an exaggerated view.

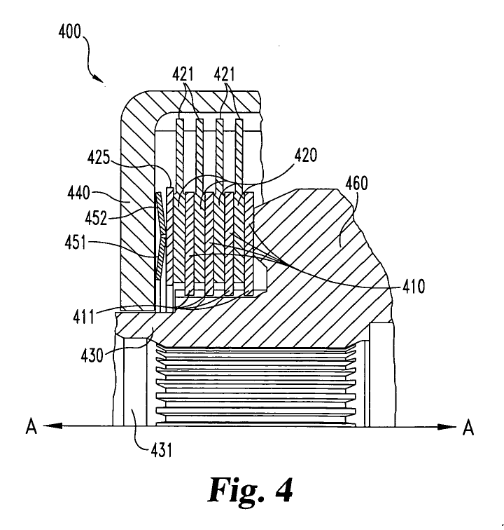

With reference to FIG. 4 there is shown limited slip differential clutch 400 according to another embodiment of the present invention. Aspects of limited slip differential clutch 400 which are similar to or the same as those described above in connection with FIG. 3 are labeled with similar reference numerals incremented by 100. Thus, for example, housing 340 of FIG. 3 corresponds to housing 440 of FIG. 4. Additionally, limited slip differential clutch 400 includes Belleville Springs 451 and 452 which can be the same or similar to the springs described above but have a different arrangement. Belleville springs 451 and 452 are another example of a dual Belleville spring configuration according to one embodiment of the present invention. As shown in FIG. 4, Belleville spring 452 is positioned with a radially outer portion contacting housing 440 and a radially inner portion contacting plate 425, and Belleville spring 451 is positioned with a radially outer portion contacting plate 425 and a radially inner portion contacting housing 440. In such a configuration Belleville springs can be said to face opposite directions. A number of variations and modifications of Belleville springs 451 and 452 and the other aspects of limited slip differential clutch 400, including those described above, are contemplated within the scope of the present invention.

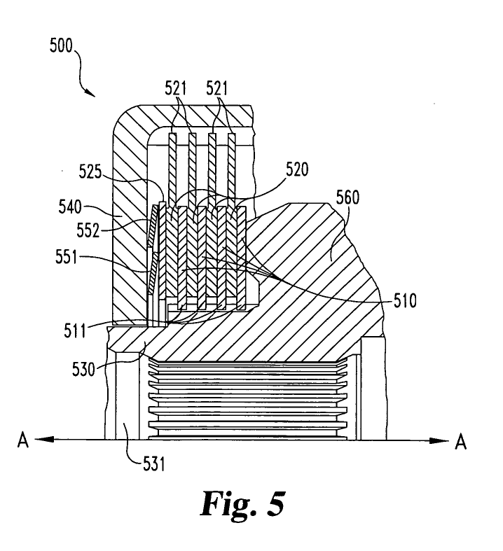

With reference to FIG. 5 there is shown limited slip differential clutch 500 according to another embodiment of the present invention. Aspects of limited slip differential clutch 500 which are similar to or the same as those described above in connection with FIG. 3 are labeled with similar reference numerals incremented by 200. Thus, for example, housing 340 of FIG. 3 corresponds to housing 540 of FIG. 5. Additionally, limited slip differential clutch 500 includes Belleville Springs 551 and 552 which can be the same or similar to the springs described above but have a different arrangement. Belleville springs 551 and 552 are another example of a dual Belleville spring configuration according to one embodiment of the present invention. As shown in FIG. 5, Belleville springs 551 and 552 are positioned with radially outer portions contacting plate 525 and radially inner portions contacting housing 540. In such a configuration Belleville springs can be said to face the same direction. A number of variations and modifications of Belleville springs 551 and 552 and the other aspects of limited slip differential clutch 500, including those described above, are contemplated as within the scope of the present invention.

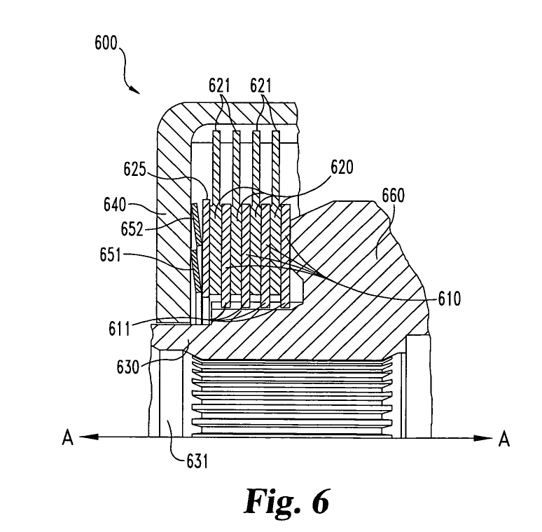

With reference to FIG. 6 there is shown limited slip differential clutch 600 according to another embodiment of the present invention. Aspects of limited slip differential clutch 600 which are similar to or the same as those described above in connection with FIG. 3 are labeled with similar reference numerals incremented by 300. Thus, for example, housing 340 of FIG. 3 corresponds to housing 640 of FIG. 6. Additionally, limited slip differential clutch 600 includes Belleville Springs 651 and 652 which can be the same or similar to the springs described above but have a different arrangement. Belleville springs 651 and 652 are another example of a dual Belleville spring configuration according to one embodiment of the present invention. As shown in FIG. 6, Belleville springs 651 and 652 are positioned with radially outer portions contacting housing 640 and a radially inner portions contacting plate 625. In such a configuration Belleville springs can be said to face the same direction. A number of variations and modifications of Belleville springs 651 and 652 and the other aspects of limited slip differential clutch 500, including those described above, are contemplated as within the scope of the present invention. Additionally, in embodiments including more than two Belleville springs, the springs could be arranged in a number of combinations of the configurations described above in connection with FIGS. 3, 4, 5, and 6 that provide any amount of desired benefits. It should be understood that at present the inventors consider the configuration of FIG. 3 to be preferred over all other configurations disclosed herein.

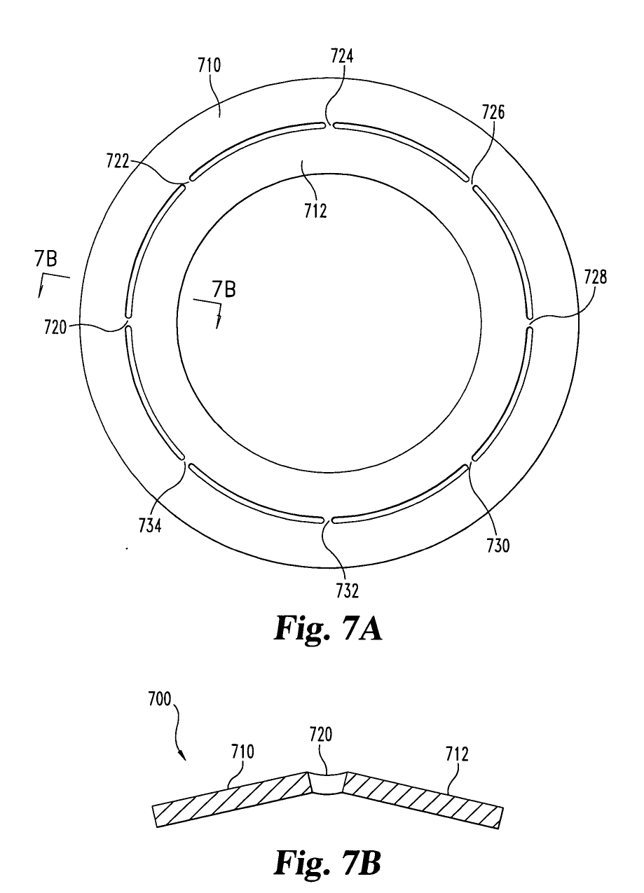

With reference to FIG. 7A there is shown a top view of Belleville springs 700 according to one embodiment of the present invention. Springs 700 include two Belleville spring portions 710 and 712 which are interconnected with bridge portions 720, 722, 724, 726, 728, 730, 732 and 734. With reference to FIG. 7B there is shown a sectional view of a portion of the Belleville springs of FIG. 7A taken along line 7B-7B. Bridge portion 720 is shown interconnecting spring portions 710 and 712. A number of variations and modifications to springs 700 are contemplated. For example, fewer or greater numbers of bridge portions could be used. The bridge portions could have a variety of different dimensions and shapes other than those illustrated. Furthermore, springs 700 are preferably formed as a single unitary piece, and could have any of the other Belleville spring properties or characteristics described elsewhere herein. Additionally the variations and modifications described above could also apply to the embodiments illustrated in FIGS. 7A and 7B.

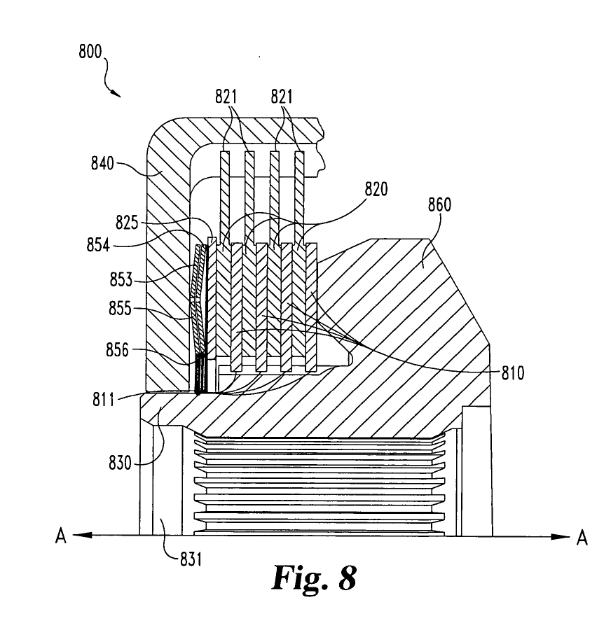

With reference to FIG. 8 there is shown limited slip differential clutch 800 according to another embodiment of the present invention. FIG. 8 illustrates an embodiment in which the Belleville springs are stacked. Springs stacked together, either inner or outer, preferably have identical or similar radial widths. Furthermore, it should be understood that the radial width of inner springs can be identical, similar, or substantially different from that of outer springs, with either inner springs wider than the outer springs or vice versa. Aspects of limited slip differential clutch 800 which are similar to or the same as those described above in connection with FIG. 3 are labeled with similar reference numerals incremented by 500. Thus, for example, housing 340 of FIG. 3 corresponds to housing 840 of FIG. 8. Additionally, limited slip differential clutch 800 includes stacked Belleville Springs 853, 854 and stacked Belleville springs 855 and 856 which can be the same or similar to the springs described above but have a different arrangement. Belleville springs 853, 854, 855 and 856 are another example of a multiple Belleville spring configuration according to one embodiment of the present invention.

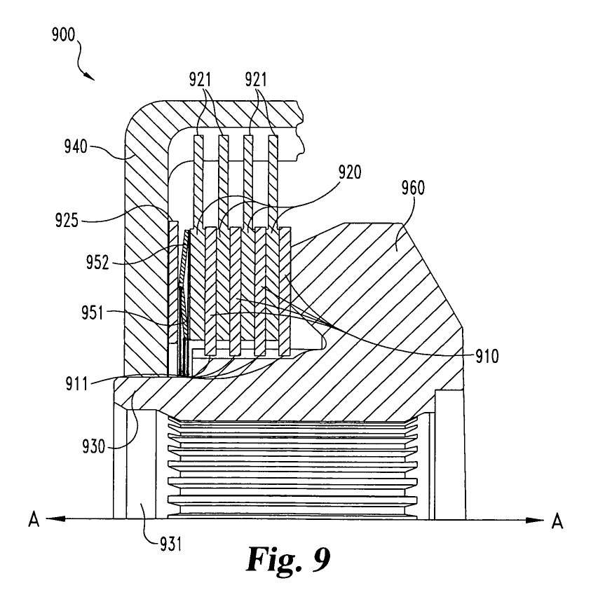

With reference to FIG. 9 there is shown limited slip differential clutch 900 according to another embodiment of the present invention. Aspects of limited slip differential clutch 900 which are similar to or the same as those described above in connection with FIG. 3 are labeled with similar reference numerals incremented by 600. Thus, for example, housing 340 of FIG. 3 corresponds to housing 940 of FIG. 9. Additionally, limited slip differential clutch 900 includes Belleville Springs 951 and 952 which can be the same or similar to the springs described above but have a different arrangement. Belleville springs 951 and 952 are another example of a dual Belleville spring configuration according to one embodiment of the present invention. In particular, the embodiment of FIG. 9 has the spacer plate 925 (or similar component) positioned between the housing 940 and the Belleville springs 951 and 952. As shown in FIG. 9, Belleville spring 951 is preferably positioned with a radially outer portion contacting spacer plate 925 and a radially inner portion contacting plate 921, and Belleville spring 952 is positioned with a radially outer portion contacting plate 921 and a radially inner portion contacting spacer plate 925. In such a configuration the Belleville springs can be said to face opposite directions. A number of variations and modifications of Belleville springs 951 and 952 and the other aspects of limited slip differential clutch 900, including those described above, are contemplated within the scope of the present invention.

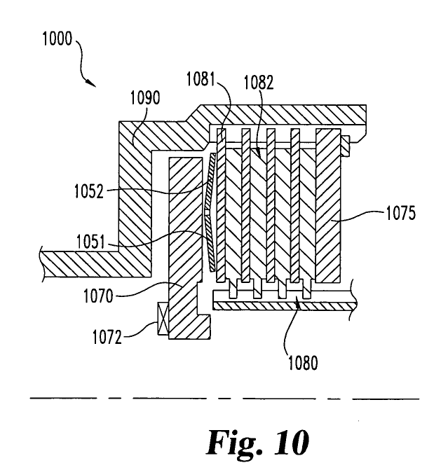

With reference to FIG. 10 there is shown limited slip differential clutch 1000 according to another embodiment of the present invention. Aspects of limited slip differential clutch 1000 which are similar to or the same as those described above in connection with FIG. 3 are labeled with similar reference numerals incremented by 700. Thus, for example, Belleville springs 351 and 352 of FIG. 3 correspond to Belleville springs 1051 and 1052 of FIG. 10. Belleville springs 1051 and 1052 are another example of a dual Belleville spring configuration according to one embodiment of the present invention. In particular, the embodiment of FIG. 10 has the Belleville springs 1051 and 1052 positioned between an actuator and the friction pack. This is intended to generically illustrate an embodiment for clutches where there is an actuator (most typically electromechanical) wherein the Belleville springs 1051 and 1052 are buffering springs positioned between the actuator's apply plate and the friction pack of disks for smooth control of axial force and thereby smooth clutch engagement rather than providing perpetual axial force. These type of clutches are used in differentials and transfer cases. Similar clutches, but typically equipped with a hydraulic actuator, are used in transmissions. In the embodiment of FIG. 10 only an apply plate of a specific clutch actuator is shown, but it should be understood that it is contemplated as within the scope of the invention that other types of actuations may be used such as, for example, hydraulic ones.

As shown in FIG. 10, Belleville spring 1051 is preferably positioned with a radially outer portion contacting the actuator's apply plate 1070 and a radially inner portion contacting a plate 1081 of friction pack 1080. Belleville spring 1052 is positioned with a radially outer portion contacting plate 1081 and a radially inner portion contacting apply plate 1070. In addition, thrust bearing is shown at 1072 by means of which the actuator acts on the apply plate 1070 to force axial displacement. Friction pack 1080 is preferably made of alternating plates 1081 and 1082 (similar to plates 320 and 310 in FIG. 3). The other end of friction pack 1080 is in contact with backing plate 1075. The combination of the apply plate 1070, friction pack 1080, etc. preferably being within drum or housing 1090. In the configuration of FIG. 10 the Belleville springs can be said to face opposite directions. A number of variations and modifications of Belleville springs 1051 and 1052 and the other aspects of limited slip differential clutch 1000, including those described above, are contemplated within the scope of the present invention.

As previously noted, in the prior art, a single Belleville spring is used. The deflection of the spring varies during normal clutch operation along with variation of axial force applied to the clutch pack. The spring has a conical shape in the free state or when the deflection is relatively small, and it interacts only with the inner periphery of the ring-shaped plates, as shown in FIG. 2. Consequently, higher contact pressure is produced at the inner peripheries of friction interfaces in the pack. When high axial force is applied to the pack, the spring flattens, and distributes pressure more uniformly. Since more pressure is applied closer to the outer periphery, higher frictional torque is produced, which is advantageous. One disadvantage of this design is the transition from the state of small deflection of the spring to the state when it is flattened, which is accompanied by sudden torque increase. The inventors determined that the latter is a potential contributor to judder. Judder is considered one of most critical problems in friction clutches. Additionally, concentration of the pressure at the inner periphery when the spring deflection is small causes non-uniform wear of friction surfaces.

With dual or multi-Belleville springs according to some of the embodiments of the present invention, the inner spring applies pressure to the inner periphery of the plates, while the outer spring applies pressure to the outer periphery. When the springs flatten upon application of high axial force, some changes in pressure distributions on surfaces occur, but they are not accompanied by rapid change in the torque, since even at low load friction torque is produced by both inner and outer peripheries. Also, local wear is less severe since it is distributed between inner and outer peripheries of the pack.

Various embodiments of the present invention will be understood to provide, for example, an improvement over existing limited slip differential clutches. For example, some of the embodiments of the present invention provide one or more of the following: consistent torque; judder-minimized or judder-free operation; and increased durability. In particular, it should also be understood that some of the embodiments of the present invention provide much more uniform and stable distribution of contact pressure at sliding interfaces compared to the prior art. As an example of the advantage of such, this might result in smoother variation of frictional torque as a function of applied axial force, which decreases system's propensity to judder. In other words, dual (or multiple) Belleville springs can provide improvements in the form of a more uniformly distributed contact pressure along radius at many, if not all, friction interfaces. Such uniform pressure distribution assists in reducing erratic behavior of frictional torque as the force applied to the pack varies, and thus minimizes or eliminates one possible contributor to judder. As another example, this might result in reduced total wear of friction plates, which increases clutch durability.

As used herein terms relating to properties such as geometries, shapes, sizes, and physical configurations, include properties that are substantially or about the same or equal to the properties described unless explicitly indicated to the contrary.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. A torque transfer apparatus comprising:
a housing;
a friction pack including a plurality of plates;
a first Belleville spring contacting a first region of one of the plates and contacting a first region of the housing; and
a second Belleville spring contacting a second region of the one of the plates and contacting a second region of the housing.

2. The apparatus of claim 1 wherein the first Belleville spring and the second Belleville spring each have a radial width and an axial height and a diameter, and wherein the radial widths and axial heights are substantially similar and the diameters are different.

3. The apparatus of claim 1 wherein the first Belleville spring and the second Belleville spring comprise a unitary piece connected with bridge portions.

4. The apparatus of claim 1 wherein the first Belleville spring and the second Belleville spring face opposite directions and the one of the plates is a spacer plate.

5. The apparatus of claim 1 wherein the first Belleville spring and the second Belleville spring face the same direction and are concentrically nested with one another.

6. The apparatus of claim 1 wherein the first region of the housing and the second region of the housing lie in substantially the same plane.

7. The apparatus of claim 1 wherein the first Belleville spring and the second Belleville spring both extend substantially from a first radial plane along the axis to a second radial plane along the axis, the first Belleville spring and the second Belleville spring each have a radial width and an axial height and a diameter, and wherein the radial widths and axial heights are substantially similar and the diameters are different, and the first Belleville spring and the second Belleville spring are a unitary piece connected with bridge portions.

8. The apparatus of claim 1, wherein at least two Belleville springs are stacked next to one another.

9. An apparatus comprising:
a torque transfer device including a hub, a housing, and a plurality of plates, a first set of the plates coupled to and rotatable with the hub, a second set of the plates coupled to the housing;
at least two Belleville springs, both springs contacting at least one of the plates to apply force to at least two regions of the one of the plates.

10. The apparatus of claim 9 wherein the Belleville springs are connected with bridges.

11. The apparatus of claim 9 wherein the Belleville springs have substantially the same thickness and are nested with one another without contacting one another.

12. The apparatus of claim 9 wherein only one of an inner periphery and an outer periphery of the Belleville springs contacts the one of the plates in a first state and the Belleville springs flatten and contact the plate substantially along their entire radial width in a second state.

13. The apparatus of claim 9 wherein the one of the plates in contact with the Belleville springs is a spacer plate, the Belleville springs are connected with bridges, the housing is a drum, and only one of an inner periphery and an outer periphery of each Belleville spring contacts the spacer plate in a first state and the Belleville springs flatten and contact the spacer plate substantially along their entire radial width in a second state.

14. The apparatus of claim 13 wherein the torque transfer device is a friction clutch for a limited slip differential.

15. The apparatus of claim 9 wherein the torque transfer device is a friction brake.

16. The apparatus of claim 9 wherein each of the Belleville springs contacts a spacer plate of the plurality of plates and each of the Belleville springs also contacts another plate of the plurality of plates.

17. The apparatus of claim 9 wherein each of the Belleville springs contacts a spacer plate of the plurality of plates and each of the Belleville springs also contacts the housing.

18. The apparatus of claim 9 wherein at least two Belleville springs are stacked next to one another.

19. A friction torque apparatus comprising:
a friction pack including a grouping of disks;
a hub contacting a first set of the disks;
a housing contacting a second set of the disks; and
at least two spaced apart Belleville springs contacting the friction pack to apply force to the friction pack at two spaced apart regions.

20. The apparatus of claim 19 wherein the pack includes an apply plate and the springs contact the apply plate.

21. The apparatus of claim 19 wherein the springs are a unitary piece connected with at least two bridge portions, the springs have substantially the same radial width and axial height, and the springs contact one of the first set of the disks.

22. The apparatus of claim 19 wherein the frictional torque apparatus is a friction clutch for a limited slip differential and the springs reduce judder.

23. The apparatus of claim 19 further comprising a third Belleville spring contacting the friction pack effective to apply force to the friction pack substantially at a third spaced apart region.

24. The apparatus of claim 19 wherein the springs are substantially concentric with one another.

25. The apparatus of claim 24, further including an actuator, the Belleville springs contacting the actuator.

26. The apparatus of claim 24, wherein at least two Belleville springs are stacked next to one another.
